(19) United States
(12) Patent Application Publication
(10) Pub. No.: US 2013/0039612 A1
(43) Pub. Date: Feb. 14, 2013

(54) OPTICAL MODULATOR

(71) Applicants: Masaki Sugiyama, Sagamihara (JP); Yoshihiko Yoshida, Sapporo (JP); Yoshinobu Kubota, Yokohama (JP)

(72) Inventors: Masaki Sugiyama, Sagamihara (JP); Yoshihiko Yoshida, Sapporo (JP); Yoshinobu Kubota, Yokohama (JP)

(73) Assignee: Fujitsu Optical Components Limited, Kawasaki-shi (JP)

(21) Appl. No.: 13/538,094

(22) Filed: Jun. 29, 2012

(30) Foreign Application Priority Data
Aug. 9, 2011 (JP) 2011-174304

(51) Int. Cl. G02F 1/035

(52) U.S. Cl. 385/3; 385/2

(57) ABSTRACT

An optical modulator comprises a substrate having an electro-optical effect, an optical waveguide formed in the substrate, a buffer layer provided above the optical waveguide, a semiconductor film provided above the buffer layer and having an aperture at a top of the optical waveguide, and an electrode provided above the buffer layer and electrically coupled to the semiconductor film.

### CROSS-REFERENCE TO RELATED APPLICATION

This application is based upon and claims the benefit of priority of the prior Japanese Patent Application No. 2011-174304, filed on Aug. 9, 2011, the entire contents of which are incorporated herein by reference.

### FIELD

The embodiment discussed herein is related to an optical modulator used in an optical communication.

### BACKGROUND

An optical modulator using electro-optical crystals such as LiNbO₃ (LN) or LiTaO₂ substrates is formed by forming an optical waveguide either by forming a metallic film such as Ti or the like on a part over a crystal substrate to promote heat diffusion, or by exchanging a proton in a benzoic acid after patterning, and is followed by providing an electrode in the vicinity of the optical waveguide.

FIGS. 1A and 1B are a view illustrating a Mach-Zehnder optical modulator in the prior art.

FIG. 1A is a plain view of the Mach-Zehnder optical modulator, and FIG. 1 (B) is a sectional view taken along A-A′ of FIG. 1A.

An optical waveguide includes an incident waveguide 10, parallel waveguides 11-1 and 11-2, an exit waveguide 12, and a signal electrode 13 and an earth electrode 14 are provided on the parallel waveguides 11-1 and 11-2, which form a coplanar electrode.

When a z-cut substrate is used as an LN substrate 15, electrodes 13 and 14 are arranged immediately above the optical waveguide 11 to utilize refraction index changes by an electric field in the z direction. The signal electrode 13 and the earth electrode 14 are patterned on the parallel waveguides 11-1 and 11-2, respectively, and a buffer layer 16 is intermediated between the LN substrate 15 and the signal electrode 13 and earth electrode 14 to prevent light which propagates through the parallel waveguides 11-1 and 11-2 from being absorbed by the signal electrode 13 and the earth electrode 14. As the buffer layer 16, a film which includes SiO₂, TiO₂ with a thickness of around 0.2 to 2 μm, a mixture of these, or the like, is used.

A semiconductor film such as a Si film 17 or the like is provided between the buffer layer 16 and the electrodes 13, 14 to suppress a phenomenon (of temperature drift) in which the operation point changes due to a pyroelectric effect at the time as a temperature change. In other words, when spontaneous polarization occurs in the LN substrate 15 due to the pyroelectric effect, the electric field produced by electric charges generated by the spontaneous polarization is applied to the waveguides 10, 11-1, 11-2, and 12, causing an effect on light other than the electric field applied by the electric charges to occur, making the operation point of the optical modulator fluctuate. Therefore, the semiconductor film is provided to equalize distribution of the electric charges generated by the spontaneous polarization and reduce the effect of the electric field generated by these electric charges. Thus, by reducing the effect of the electric field generated by the spontaneous polarization, temperature drift can be suppressed.

When the Mach-Zehnder optical modulator is driven at a high speed, terminals of the signal electrode 13 and earth electrode 14 are connected by a resistance to make a traveling wave electrode, and a microwave signal is applied from the input side. When the resistance is connected with the terminals of the electrodes 13 and 14, the microwave signal propagating through the electrodes 13 and 14 is converted into heat by the resistance and is absorbed by the resistance without reflection. Therefore, the microwave propagating through the electrodes 13 and 14 propagates as a traveling wave without forming a standing wave by being reflected at the terminals.

During that period, since refraction indexes of the parallel waveguides 11-1 and 11-2 change to +Δna and −Δnb, respectively, due to the electric field, and a phase difference between the parallel waveguides 11-1 and 11-2 changes, the intensity-modulated signal light is output from the exit waveguide by Mach-Zehnder interference. By changing the cross-section shape of the electrode, an effective refraction index of the microwave can be controlled, and by interfacing with the speed of light and that of the microwave, a fast photoresponse property can be obtained. When the cross-section shape of the electrode is changed, the ratio of the electric field which leaves the signal electrode 13 through the LN substrate 15 to the earth electrode 14 to the electric field which leaves the signal electrode 13 through the air to the earth electrode 14 changes, and the total effective refraction index of the microwave changes.

In addition, when the traveling rate of the microwave and the traveling rate of the light differ greatly, the difference in degree between the microwave and the light increases as the signal propagates, and the modulating action of the microwave affects a wide portion of the light (the portion which is long in the traveling direction). Originally, in modulating light, it was desired to limit the modulated portion of the light, the portion indicating “0” and “1”, to a narrow range, and in such a case, it is preferable that the same modulating action affect the fixed portion of traveling light. However, when the traveling rate of the light and that of the microwave differ, the modulating action of the microwave affects the wide range of the light (the portion which is long in the traveling direction), making it impossible to generate a fast optical signal with narrow symbol intervals. Therefore, it is preferable to set the traveling rate of the light close to that of the microwave so as to make the light be a fast modulation signal having a fast photoresponse property.

In the related art, in an optical modulator provided with an optical waveguide over the substrate having an electro-optical effect, such a modulator is known as forming a conductive film on a portion where no electrode exists or providing a semiconductor film formed of Si intermediated by a SiO₂ buffer layer.

### [Prior Art Documents]

Patent Document 1: Japanese Laid-Open Patent Publication No. 08-54589

Patent Document 2: Japanese Laid-Open Patent Publication No. 03-202810

In the related art illustrated in FIG. 1, a Si film 17 is formed over the entire surface of the buffer layer 16. In this configuration, since the Si film 17 is provided between the optical waveguide 11 and the electrodes 13, 14, compared with when there is no Si film 17, the application efficiency of the electric field becomes worse and drive voltage increases. In addition, since the refractive index of Si is high, a portion of light leaks into the Si film 17, causing propagation loss of light.

FIGS. 2A to 2D are views explaining the approach to avoid the problem which the optical modulator of FIG. 1 has in the related art.

FIG. 2A is a plain view of the optical modulator and FIGS. 2B to 2D illustrate a sectional view taken along B-B′ in FIG. 2 (A). The same reference numerals are allotted to the same components as those of FIG. 1 and the explanation thereof is abbreviated.

In FIGS. 2A and 2B, only a partial Si film 17 between the electrodes 13 and 14 is left, and the remaining portion of the Si film is removed. This avoids worsening of the application efficiency of the applied voltage by the Si film 17 and is also capable of reducing light leakage into the Si film 17. Further, as illustrated in FIGS. 2C and 2D, the Si film 17 and the electrodes 13 and 14 are contacted. By contacting the Si film 17 and the electrodes 13 and 14, compared with when they are not contacted, an effect is obtained which suppresses the temperature drift over the wide range of the surface of the optical modulator even when there is only a partial Si film 17.

However, with the configuration of FIG. 2 (B), since it is hard to remove the electric charges generated at the time of a temperature change at the Si film 17, the temperature drift increases. Further, when the Si film. 17 and the electrodes 13, 14 come into contact with each other as illustrated in FIGS. 2C and 2D, during the manufacturing process, positioning of the mask for forming the Si film 17 and the mask for forming the electrodes 13, 14 must be performed with maximum accuracy, which gives rise to the problem of making the manufacturing of the mask difficult. Further, even if the mask could be manufactured with accuracy, there is a possibility that the Si film 17 and the electrodes 13, 14 will be shifted in actually forming the Si film and the electrodes 13, 14 using these masks, causing fabrication yields to deteriorate.

### SUMMARY

An optical modulator in one aspect of the embodiment as discussed hereafter includes a substrate having an electro-optical effect, an optical waveguide formed in the substrate, a buffer layer provided above the optical waveguide, and a semiconductor film provided above the buffer layer and having an aperture at a top of the optical waveguide, and an electrode provided above the buffer layer and electrically coupled to the semiconductor film.

The optical modulator in another aspect of the embodiment as discussed hereafter includes a substrate having an electro-optical effect, an optical waveguide formed in the substrate, a buffer layer provided above the optical waveguide, a first semiconductor film provided above the buffer layer, a second semiconductor film provided at a top of the optical waveguide and having a thickness thinner than the thickness of the first semiconductor film, and an electrode provided above the buffer layer and electrically coupled to the first and second semiconductor films.

According to the embodiments discussed hereafter, the optical modulator with a small temperature drift as well as a preferable application efficiency of the electric field can be provided.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIGS. 1A and 1B are views illustrating the Mach-Zehnder optical modulator in the related art.

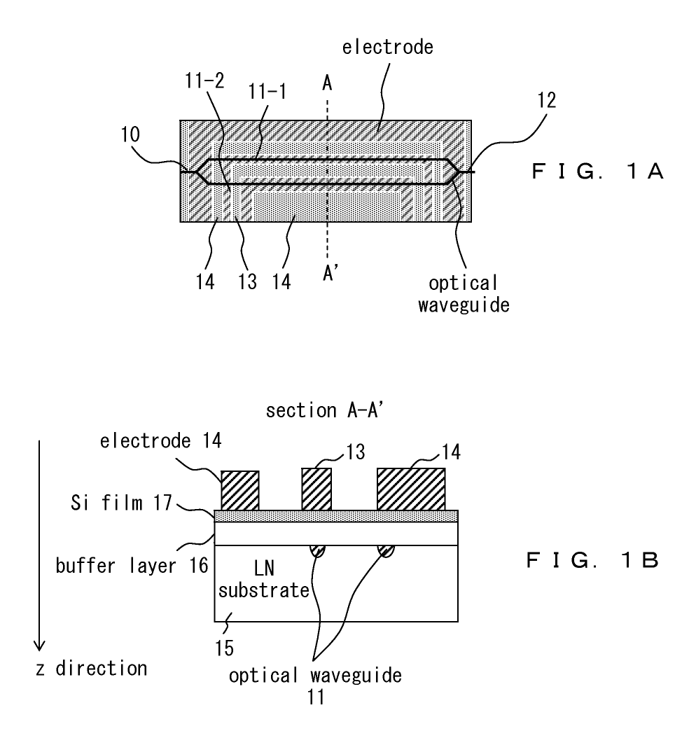

FIGS. 2A to 2D are views explaining the approach to avoid the problem used by the optical modulator of FIG. 1 in the related art.

FIGS. 3A to 3D are views (No. 1) explaining the first configuration example of the present embodiment.

FIGS. 4A and 4B are views (No. 2) explaining the first configuration example of the present embodiment.

FIG. 5 is a view illustrating a low chirp modulator using polarization inversion, which is the second configuration example of the present embodiment.

FIGS. 6A and 6B are views illustrating the third and fourth configuration examples of the present embodiment.

FIGS. 7A to 7C are views illustrating the configuration example of the present embodiment applied to an optical modulator other than the Mach-Zehnder modulator.

### DESCRIPTION OF EMBODIMENTS

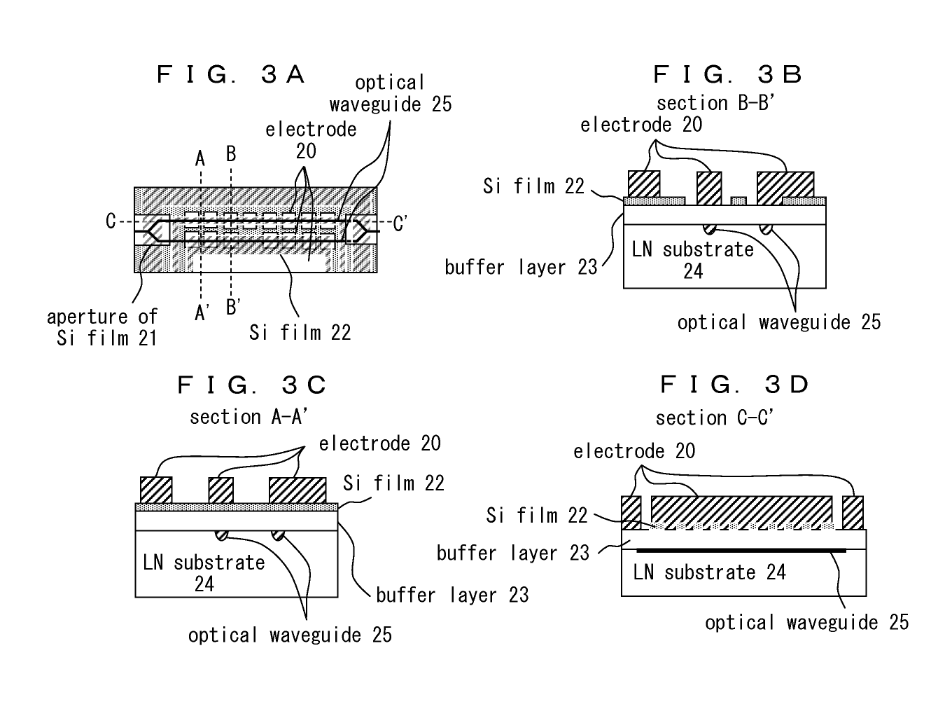

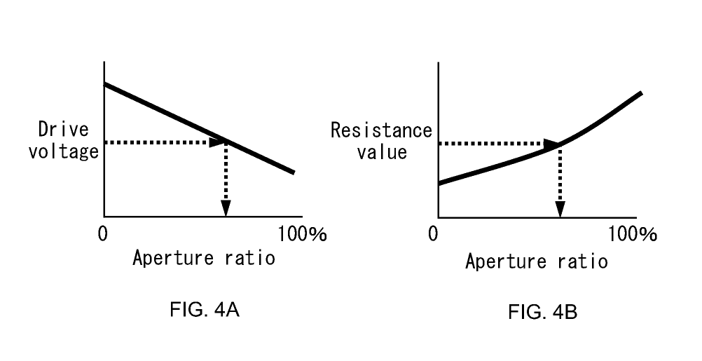

FIGS. 3A to 3D, 4A and 4B are views explaining the first configuration example of the present embodiment.

FIG. 3A is a plain view of a Mach-Zehnder optical modulator according to the present embodiment, FIG. 3B is a sectional view taken along B-B′, FIG. 3C is a sectional view taken along A-A′, and FIG. 3D is a sectional view taken along C-C′. Further, FIG. 4A and 4B are views explaining a decision technique of the ratio of a portion where the Si film exists and a portion where the Si film has been removed.

In the present embodiment, as illustrated in FIG. 3A, for example, an aperture 21 is provided on a plurality of portions of the Si film 22, so that the Si film 22 is interposed by the electrode 20 (electrode 20 refers to a collective term for the electrodes divided into three) and the buffer layer 23 at a plurality of portions, that is, the Si film 22 and the electrode 20 are configured to be contacted at a plurality of portions. By partially opening the Si film 22 (e.g., by removing the Si film on the waveguide at a plurality of portions), deterioration of the application efficiency of the electric field by the Si film 22 is reduced. In addition, by causing the Si film 22 to be contacted by the electrode 20 at a plurality of portions, the Si film 22 is conductively coupled with the entire surface of the optical modulator of FIGS. 3A to 3D. This enables the Si film 22 to average the effect of the spontaneous polarization generated by the pyroelectric effect in the LN substrate 24 over the entire surface of the optical modulator. The spontaneous polarization generated by the pyroelectric effect has a negative effect of making the modulating operation non-uniform when generated differently depending on the sites. Therefore, according to the present embodiment, since the effect of the spontaneous polarization is averaged over the entire surface of the optical modulator, the negative effect to the modulating operation is reduced, and therefore the generation of the temperature drift is lessened.

In the section A-A′ of FIG. 3C, the Si film is interposed by the electrode 20 and the buffer layer 23, and in the section B-B′ of FIG. 3B, the Si film 22 above the waveguide is removed. The electric charges generated by the pyroelectric effect at the time of a temperature change are removed at the portion of the section A-A′ (FIG. 3C) where the Si film 22 comes into contact with the electrode 20, and the temperature drift is suppressed. In addition, due to the existence of the portion of the section B-B′ (FIG. 3B), since the electric field of the electrode 20 is not hindered by the Si film 22, a loss of light is also reduced along with the reduction in the drive voltage.

In other words, improvement in the temperature property, reduction in the drive voltage, and reduction in the loss of light can be attained at the same time.

As illustrated in FIG. 3A mentioned so far, the optical waveguide 25 is provided on the LN substrate 24 having an electro-optical effect, a semiconductor film 22 such as the Si film is provided above the LN substrate 24 via the buffer layer 23, and the electrode 20 is provided above the semiconductor film 22. The semiconductor film 22 has an aperture 21 above the optical waveguide 25, and the semiconductor film 22 comes into contact with the electrode 20 interposed by the electrode 20 and the buffer layer 23 at a plurality of portions. In FIG. 3A, the portion existing above the optical waveguide 25 and the portion not existing above the optical waveguide 25 of the semiconductor film (Si film 22) are alternately arranged in the propagating direction of the optical waveguide 25.

Using this configuration, an optical modulator with a slight temperature drift and a good application efficiency is provided. Further, this configuration has an advantage with respect to manufacturing as well. In addition, although in FIG. 3A a configuration is disclosed that is provided with an electrode 20 on the semiconductor film 22, a configuration may be employed such that the electrode 20 electrically comes into contact with the semiconductor film 22 in a state where the electrode 20 is formed on the buffer layer 23 instead of on the semiconductor film 22.

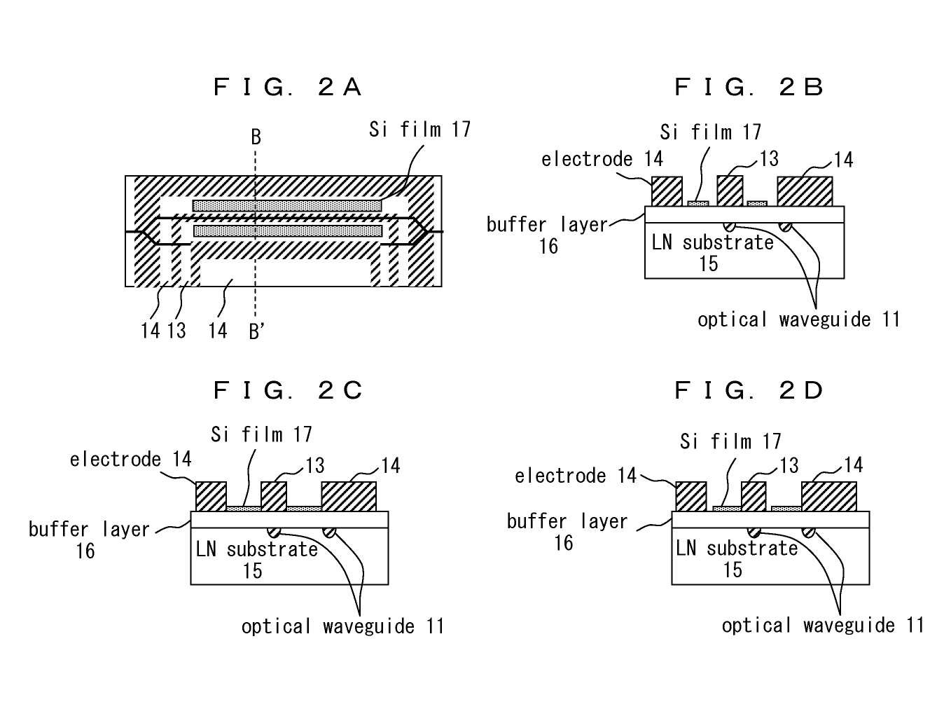

In the conventional configuration as illustrated in FIG. 2, it is required that the mask of the Si film and the mask of the electrode be accurately fitted, and when the masks are shifted and the Si film and the electrode are separated, the temperature drift dramatically deteriorates. In other words, fabrication yield deteriorates occurs.

On the other hand, the section B-B′ in the present embodiment is as illustrated in FIG. 3B. As illustrated in FIG.

3B, the width of the aperture of the Si film 22 in the width direction of the optical waveguide 25 is set to be greater than the width of the optical waveguide 25. It is preferable to set the width of the aperture of the Si film 22 so that the Si film 22 does not touch the optical waveguide 25, depending on the positioning accuracy at the time of manufacturing. The section C-C′ is as illustrated in FIG. 3D. Since the contact area of the electrode 20 and the Si film 22 does not change greatly even when the pattern of the electrode 20 is shifted against the pattern of the Si film 22 in the horizontal direction, the deterioration in the temperature character by the pattern shift does not occur.

FIG. 4A and 4B are views explaining how to determine the ratio of the aperture size. FIG. 4A is a view illustrating changes of the drive voltage applied to the electrode to the ratio of the area of the aperture, with the lateral axis indicating the ratio of the area of the aperture and the longitudinal axis indicating the drive voltage. FIG. 4B is a view illustrating changes of the resistance value to the ratio of the area of the aperture, with the lateral axis indicating the ratio of the area of the aperture and the longitudinal axis indicating the resistance value of the Si film.

As seen from FIGS. 4A and 4B, when the ratio of the area of the aperture size increases, the drive voltage decreases and the resistance value increases. Since it is more preferable to increase the ratio of the aperture to lower the drive voltage, and since it is more preferable to decrease the resistance value of the semiconductor film (Si film) to stabilize the temperature character, a trade-off exists between the two sides.

In order to determine the ratio of the area of the aperture size, such a trade-off should be considered. After grasping how the drive voltage and the resistance value change when the ratio of the area of the aperture size is changed and determining the target drive voltage and resistance value, the ratio of the area of the aperture is determined.

It is important for the optical modulator configured as a Mach-Zehnder optical modulator, to efficiently remove the electric charges generated between the two optical waveguides which constitute the Mach-Zehnder optical modulator. Therefore, the optical modulator is configured such that the optical waveguides form a Mach-Zehnder modulator and that the semiconductor film (Si film) between the two optical waveguides which constitute the Mach-Zehnder modulator is interposed by the electrode and the buffer layer at a plurality of portions.

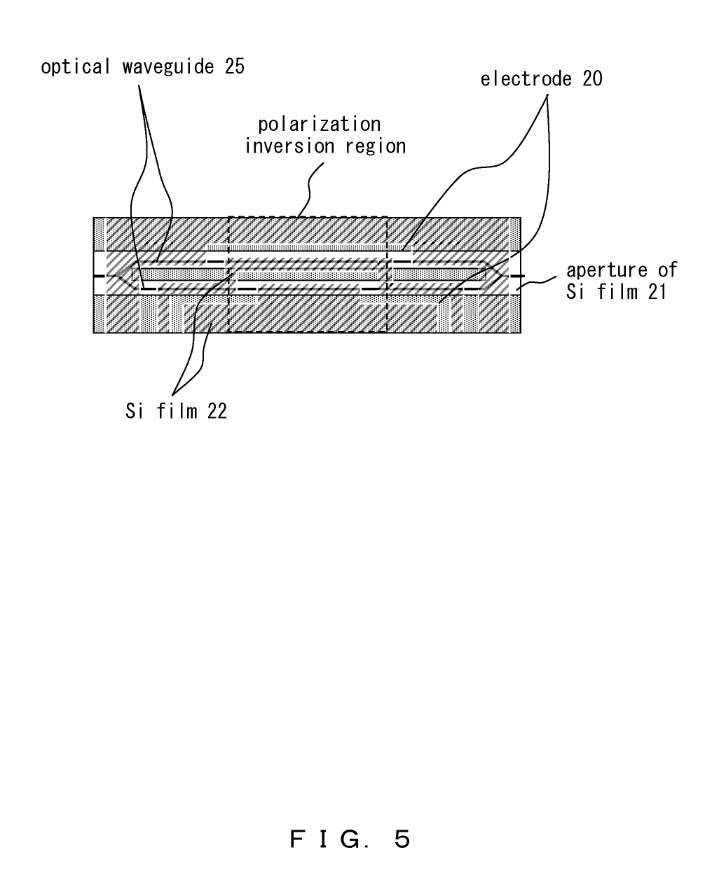

FIG. 5 is a view illustrating a low chirp modulator using polarization inversion which is a second configuration example of the present embodiment.

In FIG. 5, the portion surrounded by dotted lines is the polarization inversion region. As in FIG. 5, when the electrode 20 (electrode 20 refers to a collective term for the electrodes divided into three) is provided across the optical waveguides 25, by alternately arranging the portion coming into contact with the electrode 20 and the portion not coming into contact with the electrode 20 (aperture) of the semiconductor film (Si film 22) in the propagating direction of the optical waveguides 25, the application efficiency of the electric field is improved and the loss by the leakage of the optical energy is reduced as well, since the Si film and the electrode are contacted even without the Si film on the optical waveguides 25.

Since the electric charges generated by the pyroelectric effect shift from the electrode 20 through the Si film 22 to the electrode 20, when there is a portion separated from the Si film 22 connecting between the electrodes 20, in the vicinity of the such a portion, a locally strong electric field is generated, which deteriorates the temperature character. Therefore, care is taken so that the electric charges do not remain in the vicinity of the optical waveguides 25 by dividing the aperture 21 into a plurality of portions. In order to improve the application efficiency of the electric field and to reduce the loss by the leakage of the optical energy, even though it is preferable to have a smaller amount of Si film above the optical waveguides 25, when the amount is too small, the temperature drift deteriorates, and therefore, a shape or an area of the region on which the Si film is provided is adjusted within the range in which the resistance value of the semiconductor film (Si film) 22 is smaller than the resistance value of the buffer layer. The optical loss and the drive voltage are in a trade-off relationship and when the buffer layer is thinned, the drive voltage is reduced, and when the buffer layer is thickened, the optical loss is reduced. In the conventional configuration in FIG. 2, loss reduction was considered to be a role of the buffer layer, while with the loss reduction effect of the present embodiment, since the role of the buffer layer for reducing loss is reduced, it is desirable to obtain the effect of reducing the drive voltage by setting the thickness of the buffer layer to be not greater than 1 μm.

In the present embodiment, since the width of the Si film gets narrower compared with the conventional embodiment, peeling-off of the Si film is a concern. Also, the degree of adhesion between the buffer layer and the electrode is important.

Therefore, the electrode is configured to include a layer which includes Ti and Au, e.g., the electrode is formed of two layers, Ti and Au. Since Au has a small resistance value, it is available for applying the drive voltage; however, it has a weak adhesiveness with the buffer layer and is easily peeled off.

Therefore, by using Ti, which has a strong adhesiveness with the buffer layer directly for the adhesion surface of the electrode and the buffer layer, the peeling-off of the electrode from the Si film is suppressed.

Since the area of the Si film of the present embodiment is smaller than the conventional embodiment, there is a possibility that the resistance between the electrodes will increase and the temperature character will deteriorate. Therefore, it is desirable to set the thickness of the Si film of the non-removed portion to be not less than 0.1 μm.

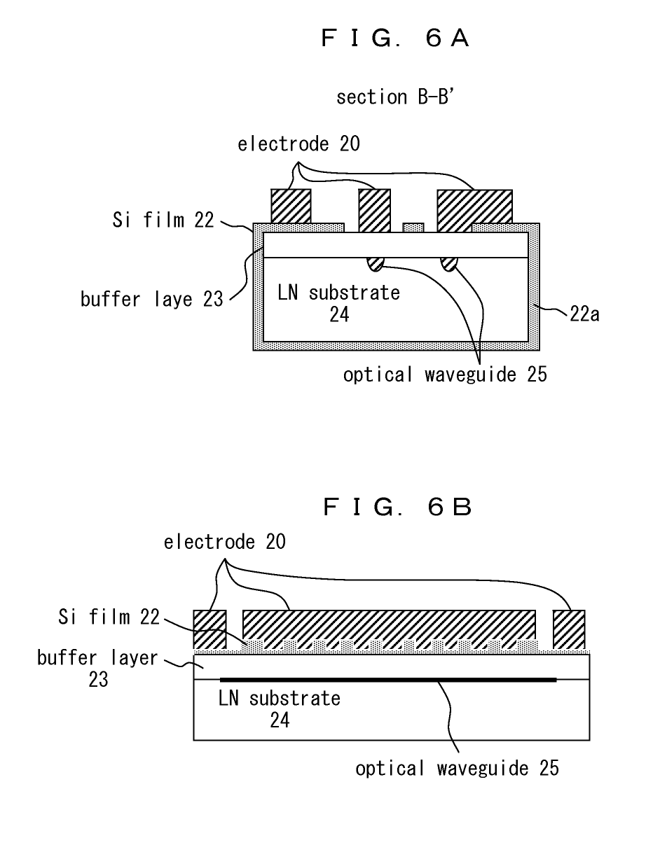

FIG. 6A and 6B are views illustrating the third and fourth configuration examples of the present embodiment.

In the third configuration example in FIG. 6A, the semiconductor film (Si film 22a) is provided on a lateral surface and a rear surface (bottom surface) of a chip which includes the LN substrate 24, the buffer layer 23, and the optical waveguide 25. Then, the semiconductor films (Si films) 22 and 22a are conductively coupled. Thus, when the Si film 22a is provided to surround the LN substrate 24 in which the spontaneous polarization is generated, the Si film 22a, together with the Si film. 22, tries to equalize electric charge distribution on the chip surface. Thus, by providing the Si film which has an action of equalizing the electric charges not only on the chip surface but also on the lateral surface and the rear surface (bottom surface), stronger action for equalizing the electrical charges is generated, which enables suppression of the negative effect by the spontaneous polarization more strongly. In addition, by providing the Si films 22 and 22a over such a wide area, the increase in the resistance between the electrodes is suppressed, thereby being capable of suppressing the increase in the drive voltage.

In addition, in FIG. 3D, there are portions with or without the Si film on the optical waveguides, and since the mode field of the light changes depending on the portions with or without the Si film by the effect of the refraction index of the Si film, there is a possibility that an optical scattering loss will occur. Therefore, as illustrated in the fourth configuration example of FIG. 6B, the semiconductor film (Si film) is not removed completely, but the thinner portion and the thicker portion of the semiconductor film (Si film) are configured to be alternately arranged in the propagating direction of the waveguide. The thickness of the thicker portion of the semiconductor film is set to be around the thickness stated in the first configuration example, and the thinner portion is set to be the one to suppress the change in the mode field of the light to within the acceptable range. The specific thickness of the semiconductor film is determined by experiment and the like. Since some portions of the Si film are thin, they have the effect of suppressing the increase in the drive voltage. Since some portions of the Si film are thick, they suppress changes in the operational point (temperature drift) by the generation of the spontaneous polarization.

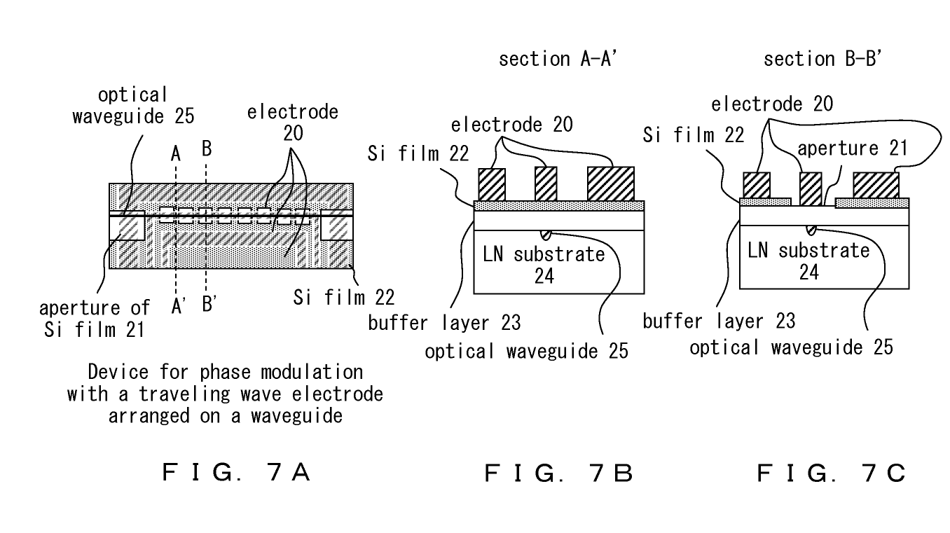

FIGS. 7A to 7C are views illustrating a configuration example in which the present embodiment is applied to an optical modulator other than a Mach-Zehnder modulator.

FIG. 7A is a plain view, FIG. 7B is a sectional view taken along A-A′, and FIG. 7C is a sectional view taken along B-B′ .

As illustrated in FIG. 7A, unlike the Mach-Zehnder modulator, this optical modulator is provided with only one optical wavelength 25. As illustrated in FIG. 7B, in the LN substrate 24, the optical waveguide 25 is formed, and above the optical wavelength 25, the buffer layer 23 is provided. Further, above the buffer layer 23, the Si film (semiconductor film) 22 is provided, and above the Si film, the electrode 20 is provided. As illustrated in FIG. 7C, along the optical waveguide 25, an aperture 21 with the Si film partially removed is provided. The aperture 21 is divided into a plurality of portions, and is configured such that the electrode 20 and the semiconductor film (Si film) 22 are made to come into contact with each other (conductively coupled) at a plurality of portions. The ratio of the area of the aperture 21 is determined in a similar manner as explained using FIG. 4.

An optical modulator as illustrated in FIG. 7 includes an optical phase modulator.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present invention has (have) been described in detail, it should be understood that the various changes, substitutions, and alterations could be made hereto without departing from the spirit and scope of the invention.

What is claimed is:

1. An optical modulator comprising:
a substrate that has an electro-optical effect;
an optical waveguide formed in the substrate;
a buffer layer provided above the optical waveguide;
a semiconductor film provided above the buffer layer and that has an aperture at a top of the optical waveguide; and
an electrode provided above the buffer layer and electrically coupled to the semiconductor film.

2. The optical modulator according to claim 1, wherein
the semiconductor film and the aperture are alternately provided along the optical waveguide.

3. The optical modulator according to claim 1, wherein
a width of the aperture in a width direction of the optical wavelength is larger than the width of the optical wavelength.

4. The optical modulator according to claim 1, wherein
a resistance value of the semiconductor film is smaller than the resistance value of the buffer layer.

5. The optical modulator according to claim 1, wherein
a thickness of the buffer layer is not greater than 1 μm.

6. The optical modulator according to claim 1, wherein
the electrode comprises a layer which includes Ti and a layer which includes Au.

7. The optical modulator according to claim 1, wherein
a thickness of a portion where the semiconductor film is not removed is not less than 0.1 μm.

8. The optical modulator according to claim 1, wherein
the semiconductor film is also provided on a lateral surface and a rear surface of the substrate.

9. The optical modulator according to claim 1, wherein
the optical waveguide comprises an incident waveguide, a parallel waveguide, and an exit waveguide, and constitutes a Mach-Zehnder modulator.

10. An optical modulator comprising:
a substrate that has an electro-optical effect;
an optical waveguide formed in the substrate;
a buffer layer provided above the optical waveguide;
a first semiconductor film provided above the buffer layer;
a second semiconductor film provided at a top of the optical waveguide and that has a thickness thinner than the thickness of the first semiconductor film; and
an electrode provided above the buffer layer and electrically coupled to the first and second semiconductor films.
